(19) United States
(12) Patent Application Publication
(10) Pub. No.: US 2022/0375175 A1
(43) Pub. Date: Nov. 24, 2022

(54) System For Improving The Precision and Accuracy of Augmented Reality

(71) Applicant: The Fire Solutions Group, LLC, Seven Valleys, PA (US)

(72) Inventors: James Andy Lynch, Seven Valleys, PA (US); Michael Ferreira, Parkton, MD (US)

(73) Assignee: The Fire Solutions Group, LLC, Seven Valleys, PA (US)

(21) Appl. No.: 17/751,045

(22) Filed: May 23, 2022

Related U.S. Application Data
(60) Provisional application No. 63/191,415, filed on May 21, 2021.

(51) Int. Cl. G06T 19/00

(52) U.S. Cl. CPC G06T 19/006; G06T 2200/24

(57) ABSTRACT

A system and method of preparing an augmented reality display system is provided and includes an augmented reality editor, a neural network, and an augmented reality viewer. The augmented reality editor is configured to allow editing and entry of volume information for access by the augmented reality viewer that is configured to generate an augmented reality composite image. The augmented reality editor includes an editor display device, electronic memory storage, a computer accessible database containing volume information stored in the electronic memory storage and identifying property features from at least a first data gathering source and at least a second data gather source, and a computational device and editing software configured to allow entry and selective modifications to the volume information. The neural network may access the volume information and assign a weight value for each of the data gathering sources used.

### CROSS-REFERENCE TO RELATED APPLICATIONS

This application claims the benefit of the filing date under 35 U.S.C. § 119(a)-(d) of U.S. Provisional Application No. 63/191,415 filed on May 21, 2021.

### FIELD OF THE INVENTION

The present invention relates to the placement of Augmented Reality (AR) digital media in an environment. More particularly, the invention relates to utilizing artificial intelligence to evaluate and weigh multiple location-based methodologies for the accurate and precise placement of AR digital media in varying environments.

### BACKGROUND

AR is defined as an interactive experience of a real-world environment where the objects that reside in the real world are enhanced by computer-generated perceptual information. AR is a system that possess three basic features: a combination of real and virtual worlds, real-time interaction, and accurate 3D registration of virtual and real objects.

In its most mature form, AR will utilize a complete understanding of the user's position, pose, and surroundings. When a comprehensive and accurate knowledge of the location, pose, and surroundings is reached, AR can fulfill its potential as a spatial operating system where multiple hardware and software interactions can coexist.

When discussing positioning for AR, we are looking for accuracy and precision in a spatial mesh that encompasses the user's field of view. The terms “accuracy” and “precision” are often used interchangeably. But they identify two distinct concepts. With reference to AR use, “accuracy” refers to how close to the target a location readings fails, whereas “precision” refers to how tightly grouped or consistently placed the location readings are.

With precise and accurate AR placement, the world can meld physically and digitally. One major hurdle in achieving this level of maturity for AR is the consistent and sustainable placement of AR in the outdoor environment or large volume spaces.

As the market stands today, the majority of AR applications are rooted in the unassuming overlay of a digital image. This overlay may be aided by simplistic identification of a feature such as a face, or surface plane in the images field of view

In more complex AR interactions indoor facilities are mapped to create a point cloud and area targets for image placement. The point cloud is then referenced by hardware to position the user in the space.

In one commercially available service, Matterport utilizes a camera with visual and Infrared (IR) sensors to create a 3D map, referred to as a doll house view, of a structure. AR can be then be accurately and persistently placed in the location within the 3D space using PTC's Vuforia engine.

Inclusion techniques allow the digital images to interact with static and transient objects using the point cloud and Simultaneous Localization and Mapping (SLAM).

Currently, satisfactory AR performance has only been obtainable within indoor applications because of the small volumes and large amount of static positional indicators. The hardware limitations of IR and LiDAR sensors are not exceeded indoors. The simplicity of the wall, ceiling and floor planes provide more than adequate surfaces to position AR. The limited or controlled range in lighting, physical changes, and field of view provide a narrow set of variables to contend with.

To realize the full potential of AR, the outdoor environment will need a platform that provides the same accuracy as the indoor environment. This will allow AR to seamlessly transverse between indoor and outdoor spaces.

However, the outdoor environment becomes substantially more complex. The complex geometries, expansive horizons, environmental conditions, number of transient objects, and the large set of environments (industrial, agricultural, city, parks) makes outdoor AR a significant challenge.

Many techniques have been utilized with varying degrees of success. When you examine the current state of the hardware and their sensor combinations, the location and pose of a user during AR is based on GPS, accelerometer, gyroscope, machine vision, and point cloud comparison utilizing LiDAR or IR sensors.

Current methods for AR placement depend heavily on a single technique, for example, Immersal has 3D mapped and created a point cloud of Helsinki, Finland, utilizing image analysis via machine vision. The technique employed by Immersal requires putting together a massive amount of images, from numerous angles, that are then processed into a 3D space database that is loaded back down to the device. Facebook has started a project to map using LiDAR sensors built into a set of glasses as part of their Facebook Reality Labs effort. Facebook also acquired Scape.io which used computer vision routines to map out most of London. Facebook has also been doing some test areas in other cities around the world. Apple has begun utilizing LiDAR on the newest iPhone and iPad. The company 6D.ai, which has been acquired by Niantic, is leveraging Pokémon GO players to bolster its 3D data collection, allowing users to share videos of real-world locations that Niantic will crowdsource, in order to create rich 3D maps. Infrared has been cast aside for outdoor use, due to interference from the sun resulting in a limited window of use for mapping.

Both machine vision and LiDAR have their limitations and will perform differently based on application and the reference data available. It is worth noting that a single position's accuracy and precision is not the goal, rather the goal of AR is to create a positional mesh where every point in the user's field of view can be accurately and precisely represented.

What is needed is a system that can be utilized for creating AR images both indoor, as well as outdoor, that uses machine learning or intelligence to optimize the resulting display for a multitude of condition.

### BRIEF SUMMARY OF THE INVENTION

This invention is a comprehensive AR platform to accurately and precisely place AR digital media. The invention will build upon the current techniques by implementing Artificial Intelligence (AI) in the form of a Neural Network (NN). The NN will adjust the weighted value of the techniques based upon learned applicability of any signal technique's performance indicators or combination of techniques' performance indicators compared to one another for a given application.

In an exemplary embodiment, there is provided an augmented reality display system, the augmented reality display system having as major components an augmented reality editor, a neural network, and an augmented reality viewer. In an embodiment, the augmented reality editor is configured to allow editing and entry of volume information for access by the augmented reality viewer configured to generate an augmented reality composite image. In an embodiment, the augmented reality editor includes: an editor display device, electronic memory storage, a computer accessible database containing volume information stored in the electronic memory storage and identifying property features from at least a first data gathering source and at least a second data gather source, and a computational device and editing software configured to allow entry and selective modifications to the volume information. The neural network may access the volume information, and assign a weight value for each of the data gathering sources used; wherein the weighted values of each of the data gathering sources are combined to form a weighted combined value as assigned by the neural network. In an exemplary embodiment, the augmented reality tool viewer includes: a viewer display device, a user interface, at least one sensor, and a computing device and viewing software configured to electronically access the computer accessible database and create a composite image for viewing on a display, the composite image comprising the volume information overlaid upon an image, wherein the volume information includes the weighted combined value as assigned by the neural network.

In an exemplary embodiment of the augmented reality display system, the first and second data gathering source is selected from the group consisting of GPS, Cellular, gyroscopes, accelerometers, machine vision, lidar sensors and infrared sensors. In an embodiment, the first and second data gathering sources are different.

In an embodiment of the augmented reality display system, the neural network utilizes three or more data gathering sources for assigning the weighted combined value for an entry. In an exemplary embodiment of the augmented reality display system, the neural network reviews a key performance indicator associated with each of the data gathering sources utilized, and scales the importance of each methodology represented by each of the data gathering sources utilized by assessing the key performance indicators for each of the data gathering sources.

In an exemplary embodiment of the augmented reality display system, the sensor augmented reality tool viewer is selected from the group consisting of camera, GPS, Cellular, gyroscopes, accelerometers, machine vision, lidar sensors and infrared sensors.

### BRIEF DESCRIPTION OF THE DRAWINGS

Some embodiments of the present invention are illustrated as an example and are not limited by the figures of the accompanying drawings, in which like references may indicate similar elements and in which;

FIG. 1 depicts a representative example of various location and positioning technologies and methodologies working together in an area for AR placement;

FIG. 2 depicts a block diagram of platform process for user input to user output through technologies, methodologies, key performance indictors extracted from each technique, and the AI analysis of the KPIs to determine weighted importance of each technique to give the best location and positioning results;

FIG. 3 depicts potential area or use in city;

FIG. 4 depicts potential area or use in rural area;

FIG. 5 depicts a flow diagram showing the components of an AR system according to an embodiment the invention; and

FIG. 6 depicts a schematic diagram showing communication paths from the data storage to multiple AR Viewers according to an embodiment of the invention.

### DETAILED DESCRIPTION OF THE INVENTION

The terminology used herein is for the purpose of describing particular embodiments only and is not intended to be limited of the invention. As used herein, the term “and/or” includes any and all combination of the one or more of the associated listed items. As used herein, the singular forms “a”, “an”, and “the” are intended to include the plural forms as well as the singular forms, unless the context clearly indicates otherwise. It will be further understood the terms “comprises” and/or “comprising”, when used in this specification, specify the presence of stated features, steps, operations, elements, and/or components, but not preclude the presence or addition of one or more other features, steps, operations, elements, components, and/or groups thereof.

Unless otherwise defined, all terms (including technical and scientific terms used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

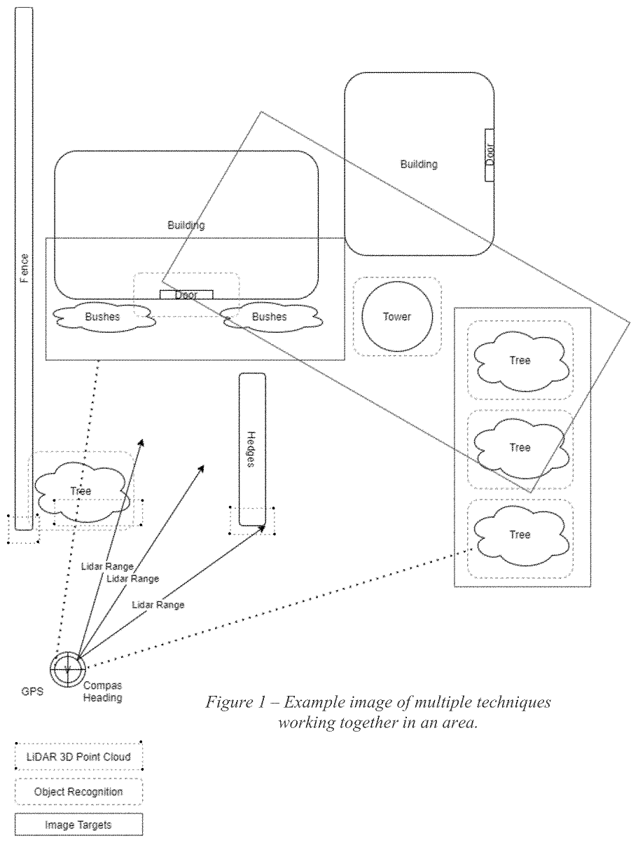

There are several technologies used to locate and place AR digital media including GPS, Cellular, gyroscopes, accelerometers, machine vision, and LiDAR to name a few. Examples of various technologies and representations of how these technologies may be employed for locating and placing AR digital media can be seen with reference to FIG. 1.

Each of these technologies can be further broken down into various methodologies

Area targets can serve as environment tracking features that enable an AR system to track and augment areas and spaces. By using a 3D scan as an accurate model of the space to create an area target device database, an AR system can deliver augmentations to stationary objects in the scanned environment. Area Targets are created by delivering a digital model obtained by using any of the supported 3D depth scanning technologies, in the depicted exemplary embodiment of FIG. 1, LiDAR is utilized for depth scanning. The digital model is imported into an area target generator, which returns a set of dataset files, meshes, and Unity packages to allow sharing or re-use of the packaged assets of the project.

Model targets allow recognition of common objects or structures. We can use these targets which allow us to pre-scan specific items into the AR database so that common items can trigger AR, identify fixed objects for comparison to previously prepared map or object database, such as a GIS database or satellite imagery, and thus allow AR in locations that have not been pre-scanned. For instance, all trees in a forest could be recognized easily from one model tree that has been scanned, and thus the system doesn't have to process each tree individually. In another example, a fire hydrant is scanned so the system could reference that hydrant and every time it sees a hydrant it would know it is a hydrant and could then reference that hydrant to a map of the area as an anchor point for triangulation.

There are multiple machine vision techniques that can be employed within the system. Image comparisons can be used to triangulate location, provide depth of field, and build 3D models. The data obtained from the image analysis can then be compared to GIS and satellite imagery to obtain the position of the user and AR.

In addition to the 3D maps; other information sources such as satellite imagery, GIS, digital images, and other AR information that will be accessed by the various positioning methodologies prior to becoming a Neural Network input (NN input) will be stored in a remote, electronically accessible database, such as an Amazon Web Services (AWS) database. The database will also store the AR digital markers and their location within the point clouds.

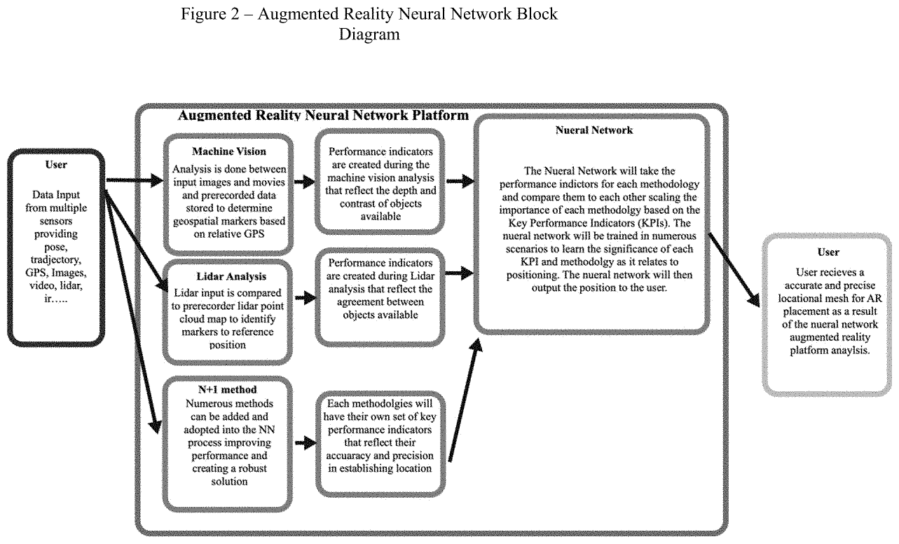

The invention builds upon the current techniques by implementing Artificial Intelligence (AI) in the form of a Neural Network (NN). The NN will be capable of adjusting the weighted value assigned for the various techniques utilized for generating digital model records, with the weighting adjustments based upon learned applicability of any signal technique or combination of techniques for a given application, for example, as depicted in the FIG. 2. The weighted value assigned for each of the various techniques utilized may then be combined to form a weighted combined value that the NN will use for placing the volume in the AR image.

For example, in rural areas devoid of features, the limited range of LiDAR would most likely result in the NN decreasing the dependency on LiDAR while increasing the dependency onto GPS and machine vision.

In a city, the NN would decrease the dependence on GPS, where interference is likely, and be more dependent on machine vison and LiDAR.

The invention creates an AI learning platform where more and more techniques can be added and the NN can appropriately weigh the technique. The result will be a comprehensive AR location and placement solution for various applications. The weighing of the techniques may also reflect current environmental circumstances or other factors that would case one or more of the methodologies to become less accurate, such as in low light travel conditions that affect LIDAR performance or machine vision (e.g., smoke, fog, snow). In such an instance, the neural network would increase the weight of those other methodologies that are not reliant upon light detection, such as GPS, accelerometer, and gyroscope information, and may be weighed greater and be useful in generating the AR placement information, with lesser reliance for AR placement from the less weighted methodologies, as determined by the system. Thus, the system is able to adapt to current conditions, by altering the weight assigned to different methodologies of positional techniques, for creating usable AR placement information.

The neural network will evaluate key performance indicators associated with each methodology. These could include drift with GPS, contour mapping with machine vision, or Lidar points and composition, and/or environmental conditions.

The NN will function on the assumption that the more complex the input data set is for a given technique the more accurate the output position will be. The NN will take the input data, the result, and the consistency of the result for each method over time to contrast and weigh each technique. By allowing the NN to evaluate the number of datapoints, contrast in data points in different dimensions, e.g., horizontally and vertically, and complexity of the dataset, each technique will be evaluated and then compared by the NN. This will create a floating real time scale of certainty for each method and the overall result. The AR placement will then be generated using information provided by one or more of the techniques, with priority or additional weighing of the placement information generated by those techniques that are determined by the neural network to have the higher certainty score on the scale.

By training the neural network to evaluate the importance of these methodologies metrics against one another as it pertains to location position and accuracy a more robust system than any signal or combination of techniques will be created.

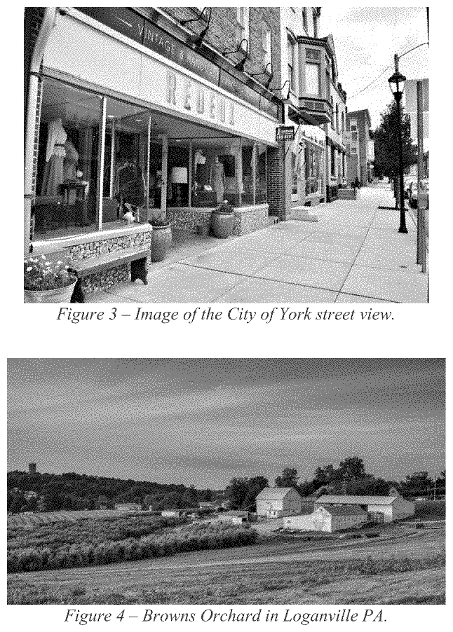

In one example in the City of York, FIG. 3, the LiDARs range in the Apple iPad (up to 5 meters) will provide a large set of complex data which will include the buildings, sidewalk, and streets. This data will have a high degree of precision and accuracy (mm). A Machine Vision technique would also provide a complex set of inputs with distance ranges much greater than LiDAR. In this scenario the two techniques would potentially be weighted in a similar manner along with the other incoming data such as pose, GPS, cellular, and GIS.

In another example, Brown's Orchard FIG. 4, the LiDAR would not provide significant complexity in the limited area the LiDAR encompasses. However, the machine vision technique, although less complex than the city, would result in input data with more complexity that that of the LiDAR because of inclusion of image features outside the range of the LiDAR. When taken into consideration with the other positioning techniques a real time moving weighted dependency would be established.

In an example where no distinguishable features exist, or can be determined, the accuracy would be completely dependent on GPS information. This is anticipated to be a very rare occurrence, as generally, at least some other form of location information would be anticipated as being available. In other areas where features exist in the foreground, outside the reach of LiDAR, GPS and machine vision will contribute, and accuracy should improve. With several features accessible by one or more of the techniques, such as LiDAR and machine vision, the accuracy of AR placement should improve even further.

The dependency of each technique will change with the position as the user completes a given task.

In an embodiment, the invention may provide an Augmented Reality (AR) system, and method of using the system. In an embodiment, the system components may include: at least one computing device having a processor and memory and be capable of electronic communication. The processor may be a central processing unit (CPU) that manipulates data stored in the memory device by performing computations, and is configured to generate the composite AR image using the input information received from the user (location and view coordinates) along with a real world image provided, such as may be provided by a user's imaging device, for example a camera associated with the user's computer, tablet, online or mobile device; whereupon the processor processes the information received from the database that is relevant to the user's viewpoint to create the overlay of the digitally stored or accessed information upon the real world image, whereupon the composite image may then be sent to the user's display. It is contemplated that the computational device may be a portable tablet computer or mobile device having a touch screen display, through which the user interface is accessed. In the depicted embodiment, the computational device may access data stored in a data storage server, which may be accessible electronically, for example, via the internet and/or in the cloud, as is known to those skilled in the art.

In an embodiment, the software is accessed or run by the processor, for example written to the memory for the processor, where the software provides for the entry of records, and converts the records into a form necessary for preparing a visual display for the AR system. Further the software provides for the rendering of the AR image on a display associated with the computing device, and also may be capable of providing location, communication, and device orientation; utilizing a location system, such as global position system (GPS) and/or a wireless communication method, for example cellular communications utilizing a plurality of cellular towers, the location system may utilize one or more of cellular tower or satellite triangulation; and any suitable method and device for data storage, which may be on the device, and/or in the cloud, such as an internet accessible data storage server in the cloud. As employed in the system of the present invention, AR provides a composite view on a display, that combines real world view and computer generated images and information in a single display image, where the computer generated portion of the image is overlaid upon a static or moving real-time image, typically corresponding to a user's view, though it is also contemplated that an optional 2-dimensional overhead plan view (i.e., satellite view) may be beneficially provided as an alternative AR view provided on a user's display. The computer generated image and information may be partially transparent, so as to not completely obscure the underlying real world image in the AR display. It is also contemplated, that where appropriate, the computer generated image and information may be created as wire frame depiction, so as to minimize interference with the underlying real world image, yet still convey the necessary AR information to the user.

It is further contemplated that in an embodiment, either the person perspective view or the plan view, the AR composite image may, as an alternative to a live camera feed, may instead combine a stored image or series of images relevant to the location coordinates, and optionally, the direction of view of the user, and thus corresponding to the actual location, and optionally view of the user, and not necessarily a real time view. In this manner, the AR image may be a representative image of the real time perspective, supplemented with information as provided through the system.

In an embodiment, the AR viewing system utilizes software that allows collects information from the various techniques described herein (such as GPS or cell tower triangulation, LIDAR, machine vision, etc.), and utilizes hardware, including a computing device and a display device. The computing device includes a user interface, a memory device, and a processor (such as a central processing unit), and be capable of electronic communication. The display device may be, for example, a mobile or fixed display, such as a touchscreen display, for example, a computer tablet or laptop display, a hand held cell phone display, portable media player, or a computer terminal display. The AR system is typically accessed via the user interface, for example, a graphical user interface (GUI), using inputs from any suitable method, for example, utilizing a keyboard, joystick, or computer mouse, or utilizing a stylus or finger, or other gestures through a touch screen display to navigate the interface.

The memory device may be a storage device having computer components and recording media used to retain digital data. The memory device may be remotely accessed, such as through a data storage server, or remote computer, or may even be stored locally in one or more users' computational device.

In an embodiment, the computational device may be the tablet or smart phone, and may have a copy of the necessary database or electronically stored information, which may be complete or partially complete of the information, locally stored in the memory accessible by the computational device. The database may be updated wirelessly, or the computational device may be placed into a network connection with another computer or server, whereupon any updates to the database information may be received through the network connection, whether wireless or wired) whereupon the most up-to-date information may be reflected in the locally stored copy of the information. Alternatively, the computational device may wirelessly access a remotely stored database, which may itself be periodically updated to include the most up-to-date information.

The processor may be a central processing unit (CPU) that manipulates data stored in the memory device by performing computations, and is configured to generate the composite AR image, using the input information received from the user (location and view coordinates) along with a real world image provided, such as may be provided by a user's imaging device, for example a camera associated with the user's computer, tablet, phone or mobile device; whereupon the processor processes the information received from the database that is relevant to the user's viewpoint, to create the overlay of the digitally stored or accessed information upon the real world image, whereupon the composite image may then be sent to the user's display.

In an embodiment of the system, each user of the AR system may be provided with one or more of a display device configured to display a relevant field of view of the user, a computing device capable of running the software and accessing information, such as files stored in databases, and also may optionally include a camera useful for generating an image of the user's view upon which AR elements may be superimposed, as will be discussed. In an embodiment, the display device and the computing device, along with an optional camera, may be combined together, for example, the AR system, may utilize a tablet, smart phone, portable media player, laptop, or an optical head-mounted display. The AR system is configured to access and may display cataloged information stored in an accessible database, for entries in the database the software designates as being relevant, based on the geospatial coordinates relevant to a specific user's view, such that the appropriate information entries can be overlaid over the appropriate real world view, or static substitute image.

In an embodiment, the real world view or image of AR system, is provided by a camera which may be associated with the display system, for example, as commonly found on tablet and personal communication devices, for example, mobile phones. It is contemplated that the camera may be functionally separated from the display, and may be associated with the user, such as a body mounted camera, helmet mounted camera, a hand held camera, or an optical head-mounted display or wearable display system (e.g., smart glasses), which may be in electronic communication, such as by being connected via wired or wireless communication connection, for example, through a network connection, to a computing device for processing of the provided image information into the AR composite image which may then be displayed on a display. It is also contemplated that the camera may be a remote camera transmitting image information for processing into the composite AR image. The location and direction of view of a user may be determined by using known geolocation techniques known in the art, for example, through the use of radio frequency location, utilizing global positioning systems (GPS) signals, cell tower transmission signal, whereby the location of each user may be determined via triangulation. Furthermore, other known techniques for ensuring accurate geolocation may be employed, including point set registration technology, and may incorporate one or more of: 3d mapping techniques that compare the real world camera view to a prepared 3D map accessible within the system, such that relevant information for that view is contained within the 3D map, and can easily be overlaid upon the real world view; and point cloud mapping, where the real world camera view can be utilized to create a point cloud map of the terrain and features, and can be compared to a 3D model. It is also contemplated that a point cloud map may be created in advance, and using the features from the point cloud map, the real world view could be registered against set points within the point cloud map. By comparing the real world view against a previously prepared map (whether 3D map or point cloud map) the accuracy of the AR composite image can be enhanced. One benefit of the AR system is that the various sources of information utilized in preparing the map can be assigned a weight, such that AR placement on the image is based on one or more information gathering techniques, with the system assigning more weight in AR placement to those techniques that are the most accurate at the time and current conditions, and less weight in AR placement to those techniques that will be less accurate at the time and current conditions. In this manner, the techniques with the highest likelihood of accurate placement in the composite view will be emphasized over other techniques.

In an embodiment, the system is provided with software that receives and processes the user's geolocation information, along with the imaging information of the user's view, whereupon the computing device will perform the necessary computations to create the composite AR image that can be sent to a display, including a composite image of the user's real world view, supplemented with the relevant catalogued information, which may be in the form of overlaid icons on the image. Further, the composite view may optionally be supplemented with additional information, the contents of which may be user selectable, such as displaying date and time, an optional overlay or inset of an alternative view, current compass heading of the user's view, location coordinates of the user, communications, texts or software notifications.

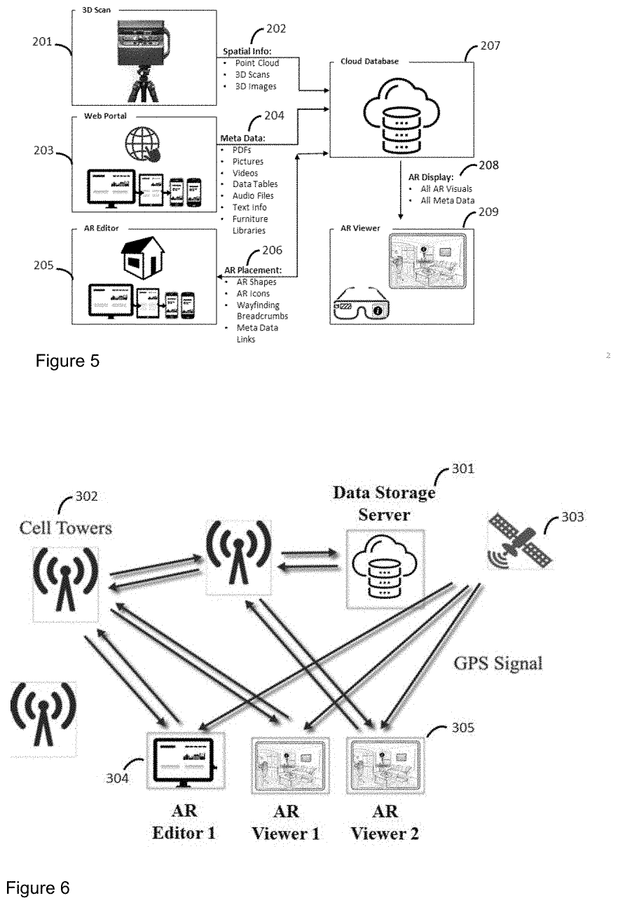

In an embodiment, a user's device of the system may perform either or both of the role of editor (generating the AR image) or that of a viewer (reviewing the generated AR image). In an exemplary embodiment, as shown in FIG. 5, the invention may provide a system consisting of a commercial 3D scanning device 201 used to record spatial information 202 for objects in the designated environment, whether indoors or outdoors, with the system utilizing the neural network to identify and assign a weighted value for each of the methodologies implemented for collecting AR information. In an embodiment, the neural network may rely on calculations and software utilizing the processor for the user's device in the AR editor 205 or AR viewer 209 (e.g., front end). In an alternative embodiment, the neural network may rely on calculations and software utilizing a processor associated with the remote cloud database 207 (e.g., back end), when the AR information is to be maintained in a local or cloud-based database 207. In an another embodiment, the web-portal software 203 enables management of metadata 204, and may perform the necessary calculations to serve as the neural network, with regard to captured or recognized features contained in the form of PDF files, pictures, videos, data tables, audio files text fields, 3D avatar video, or object libraries and enable management of that content in the database. In an embodiment, an Augmented Reality (AR) software editor 205 will download the geometry information from the database and enable definition and placement of AR elements, including AR Shapes, AR Icons, AR Text, 3D avatars, wayfinding “breadcrumbs” and meta data links. Finally, an AR Viewer 209 will enable display of all VR visuals and linked meta data on a display device configured for this purpose. Each of these system elements may exist either as a stand-alone component or be combined with one or more other components to reduce the number of independent components of the system.

With reference to FIG. 5, the computational device of each of the AR Editor or the AR Viewer may include at least a user interface, a memory device, and a processor, and be capable of electronic communication. The processor may be a central processing unit (CPU) that manipulates data stored in the memory device by performing computations, and is configured to generate the composite AR image using the input information received from the user (location and view coordinates) along with a real world image provided, such as may be provided by a user's imaging device, for example a camera associated with the user's computer, tablet, online or mobile device; whereupon the processor processes the information received from the database that is relevant to the user's viewpoint to create the overlay of the digitally stored or accessed information upon the real world image, whereupon the composite image may then be sent to the user's display. It is contemplated that the computational device may be a portable tablet computer or mobile device having a touch screen display, through which the user interface is accessed. In the depicted embodiment, the computational device of one or both of the AR Editor and AR Viewer may access data stored in a data storage server, which may be accessible electronically, for example, via the internet and in the cloud, as is known to those skilled in the art. It is contemplated that instead of a camera using light detection for formulating an image, the data collection may be performed by a sensor, or suite of sensors, which may be in alternative to, or may serve to supplement the use of a camera, in order collect spatial location and environment information, e.g., through the use of lidar, radar, GPS, compass heading, or other forms of detection that can be weighed by the neural network for identifying the objects and their locations within the environment region (e.g., indoors, outdoors, rural, urban) being recorded.

In an exemplary embodiment, the system is provided with software, designated the “AR Editor” 205 in FIG. 5, that receives and processes the user's geolocation information, along with the imaging information from the 3D camera scan or other sensors, whereupon the computing device may perform the necessary computations to create the AR elements that can be stored in the database and later sent to a display to create a composite image of the user's real world view. The neural network may assemble all of the relevant information gathered for a region, and perform the weighing to assign for each of the information gathering methodologies available, as appropriate for the type of environment detected. The composite image may be supplemented with the relevant catalogued information, which may be in the form of overlaid AR volumes and icons on the image, the icons representing features, resources, other users, furniture, architectural features, information, video, audio, documents, images, merged into the real world image or representative image of each user's perspective. Generally, it is anticipated that the generation of the AR composite image would be similarly prepared, whether within the AR Viewer or the AR Editor, and it is primarily in the manner in which data for presentation within the display can be edited or manipulated in the AR Editor by an authorized user that distinguishes the AR Editor from the AR Viewer, as it would not typically allow rights to edit the database, other than to note or flag errors for items entered into the database. In any event, the composite view may optionally be supplemented with additional information, the contents of which may be user selectable, such as displaying date and time, an optional overlay or inset of an alternative view, current compass heading of the user's view, location coordinates of the user, communications, texts or software notifications, or status of equipment, as non-limiting examples. Where an alternate view is provided as part of the composite image on the display, it may be an inset window within the real world view image, or alternatively an overlaid image, which may be partially transparent, thus the user could view the alternate view without fully obscuring at least that part of the real world view under the overlaid alternative view. The alternate view may be user-selectable to be any of: the overhead view, typically, where the user's main image is the user's perspective view; or the user's perspective view, typically, where the user's main view is the overhead view. In another exemplary embodiment, the alternative view may selectively be another user's view or composite image.

In an exemplary embodiment, the system is provided with software, designated the “Web Portal” 203 in FIG. 5, that enables management of meta data 204 including (but not limited to) PDF files, pictures, videos, data tables, audio files, text info, and furniture libraries and storage of this information in the cloud information database 207. The meta data is then in turn linked to AR objects created and defined in the AR Editor 205 for display in the AR Viewer 209. It is contemplated that the neural network may utilize the information available through the web portal 203, to perform the necessary calculations and interpretations of collected data records, to determine and assign the appropriate weight to the varied methodologies used to collect spatial information, as well as environmental information.

In an exemplary embodiment of the system, each user of the AR Viewer 209 may be able to use one or more display device configured to display a relevant field of view of the user, a computing device capable of running the software and accessing the cataloged entries, and also may optionally include a camera, and other sensors (e.g., compass, GPS, lidar) useful for generating an image of the user's view upon which AR elements may be superimposed, as will be discussed. In an exemplary embodiment, the display device and the computing device, along with an optional camera or sensors, may be combined together, for example, the AR Viewer and or AR Editor, may utilize a tablet computer, smart phone, portable media player, laptop, or an optical head-mounted display. The AR Viewer will then display those specific entries of the cataloged information the software designates as being relevant, based on the weighing applied to the various methodologies, as well as the geospatial coordinates relevant to each specific user's view, such that the appropriate information entries can be overlaid over the appropriate real world view, or static substitute image.

In an exemplary embodiment, the real world view or image in the AR Viewer is provided by a camera and/or sensors associated with the display system, for example, as commonly found on tablet and personal communication devices, for example, mobile phones. It is contemplated that the camera and/or sensors may be functionally separated from the display, and may be associated with the user, such as a body mounted camera, helmet mounted camera, a hand held camera, or an optical head-mounted display or wearable display system (e.g., smart glasses), which may be in electronic communication, such as by being connected via wired or wireless communication connection, for example, through a network connection, to a computing device for processing of the provided image information into the AR composite image which may then be displayed on a display. It is also contemplated that the camera may be a drone mounted camera wirelessly sending image information for processing into the composite AR image.

In other exemplary embodiments, the software maybe loaded onto computers, cell phones, tablets, and/or other mobile devices, such that the software is configured to communicate with a display, so as to present the composite image information to the user of the AR Viewer. The device for providing the display rendered by the software may also be a form of wearable technology capable of providing a display for the wearer, and preferably allow the wearer to see through the display. For example, where the software is loaded on a mobile device having a display the software may utilize information about the user's location and view coordinates, which may then be sent to a computational device having access to the catalogued information, whereupon the computational device may select the relevant database information as determined by the software to be applicable to the location and view coordinates of the user, selected by the user, or not otherwise to be excluded by optional filters set up in the system. The computational device may be located remotely from the user, or may be contained within the user's mobile device.

FIG. 6 shows an exemplary embodiment of the mode of communication between system components, which may include: a remote cloud-based data storage server 301 as the back-end or any other suitable method or device for data storage (such as a private server or data network), a wireless communication network 302 to provide communication between devices, a global positioning system (GPS) satellite network 303 to provide geo-location information, one or more mobile devices or computers loaded with the AR Editor software 304 and capable of rendering the AR images and transmitting back to the data server for remote storage, and one or more mobile devices loaded with the AR Viewer software 305 and capable of rendering the AR image, providing location, communication, and device orientation. As discussed previously, the calculations and logic necessary for the neural network may be performed by processors located in any suitable location with the communication network, such as a processor associated with the data storage server 301 in the back end, or in a processor associated with the device accessed by the user at the front-end, whether as an AR viewer 305 or AR editor 304. Electronic communication between the computational devices of the AR Editor or AR Viewer and the data storage server may be facilitated through any suitable form of electronic communication, for example, wireless communications, and as depicted in FIG. 6, may be provided through one or more cellular towers 302. Generally, there will be a need for the computational devices of the AR Viewer to locate and orient itself, which may be accomplished using one or more of GPS systems, cellular towers, and on-board sensing devices (e.g., accelerometer, compass) to locate and provide orientation information for the devices. The location and direction of view of each specific user may be determined by using known geolocation techniques known in the art, for example, through the use of radio frequency location, LiDAR, utilizing global positioning systems (GPS) signals, cell tower transmission signal, whereby the location of each user may be determined via triangulation.

In another exemplary embodiment, it is contemplated that location and orientation information may be supplemented by the system, utilizing image information provided by the camera for the user, from which the software may identify landmarks, or the user may interact with the software, in order to identify landmarks or features within the view to positively confirm locations for the device, or placement of icons on the display. It is contemplated that landmarks or features may be recognized by artificial intelligence or may rely on user confirmation to identify features that will provide confirmation of location for the system. The recognition of landmarks or features may be weighed in the calculations utilized within the neural network for determining the weight value to assign to the various forms of collected location information (e.g. optical sensor, lidar, etc.).

In another exemplary embodiment, other known techniques for ensuring accurate geolocation may be employed, including point set registration technology, and may incorporate one or more of: 3d mapping techniques that compare the real world camera view to a prepared 3D map accessible within the system, such that relevant information for that view is contained within the 3D map, and can easily be overlaid upon the real world view; and point cloud mapping, where a camera equipped with a LIDAR or IR scanner can be utilized to create a point cloud map of the terrain and features, and can be compared to a 3D model. It is also contemplated that a point cloud map may be created in advance, and using the features from the point cloud map, the real-world view could be registered against set points within the point cloud map. By comparing the real-world view against a previously prepared map (whether 3D map or point cloud map) the accuracy of the AR composite image can be enhanced. Direction of view of each user, or the relevant camera, may be determined using known techniques, including but not limited to the use of one or more magnetic field sensors, LiDAR, and/or one or more accelerometers, to determine the directionality of the camera view, relative to the direction of gravity and magnetic north. It is also contemplated that the system may be capable of operating without a camera providing a live view.

The foregoing illustrates some of the possibilities for practicing the invention. Many other embodiments and fields of use for a system for preparing an augmented reality display and hazards and resources database, and the components thereof contributing to the invention are possible and within the scope and spirit of the invention. It is, therefore intended that the foregoing description be regarded as illustrative rather than limiting, and that the scope of the invention is given by the appended claims, together with their full range of equivalents.

What is claimed is:

1. An augmented reality display system, the augmented reality display system comprising:
an augmented reality editor, a neural network, and an augmented reality viewer, the augmented reality editor configured to allow editing and entry of volume information for access by the augmented reality viewer configured to generate an augmented reality composite image; the augmented reality editor includes:
an editor display device,
electronic memory storage,
a computer accessible database containing volume information stored in the electronic memory storage and identifying property features from at least a first data gathering source and at least a second data gather source, and
a computational device and editing software configured to allow entry and selective modifications to the volume information; and,
wherein the neural network accesses the volume information, and assigns a weight value for each of the at least a first data gathering source and the at least a second data gathering source; wherein the weighted values of each of the at least a first data gathering and the at least a second data gathering source are combined to form a weighted combined value assigned by the neural network; and
wherein the augmented reality tool viewer includes:
a viewer display device,
a user interface,
at least one sensor, and
a computing device and viewing software configured to electronically access the computer accessible database and create a composite image for viewing on a display, the composite image comprising the volume information overlaid upon an image, wherein the volume information includes the weighted combined value as assigned by the neural network.

2. The augmented reality display system of claim 1, wherein the at least a first data gathering source is selected from the group consisting of GPS, Cellular, gyroscopes, accelerometers, machine vision, lidar sensors and infrared sensors.

3. The augmented reality display system of claim 2, wherein the at least a second data gathering source is selected from the group consisting of GPS, Cellular, gyroscopes, accelerometers, machine vision, lidar sensors and infrared sensors, and wherein the at least a second data gathering source is different from the at least a first data gathering source.

4. The augmented reality display system of claim 3, wherein the neural network utilizes three or more data gathering sources for assigning the weighted combined value for an entry.

5. The augmented reality display system of claim 4, wherein the neural network reviews a key performance indicator associated with each of the data gathering sources utilized, and scales the importance of each methodology represented by each of the data gathering sources utilized by assessing the key performance indicators for each of the data gathering sources.

6. The augmented reality display system of claim 1, wherein the sensor is selected from the group consisting of camera, GPS, Cellular, gyroscopes, accelerometers, machine vision, lidar sensors and infrared sensors.
